(19) United States
(12) Patent Application Publication
(10) Pub. No.: US 2009/0040879 A1
(43) Pub. Date: Feb. 12, 2009

(54) Wearable electronic device with multiple display functionality

(76) Inventors: Louis M. Galie, Newtown, CT (US); Wolfgang Burkhardt, Ispringen (DE); Gerhard Stotz, Eisingen (DE)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 11/891,464

(22) Filed: Aug. 10, 2007

(51) Int. Cl. G04C 17/00; G04B 19/06

(52) U.S. Cl. 368/228; 368/242

(57) ABSTRACT

A wearable electronic device for conveying information in an analog manner, wherein a controller is operable in a first mode and at least a second mode, the dial assembly is operatively coupled to the controller, and is a liquid crystal display assembly, and preferably a cholesteric liquid crystal display, wherein the dial assembly displays informational indicia corresponding to the mode in which the electronic device is operating, and wherein the informational indicia is changeable based on the mode in which the wearable electronic device is operating; and wherein the positioning of the display hand as it rotates in the one of the clockwise and counterclockwise directions in the predefined increments conveys the information by referring to particular informational indicia, and wherein the controller operatively controls the positioning of the hand so that the hand can convey the information in the analog manner for each of the at least two modes.

### BACKGROUND OF THE INVENTION

This invention relates generally to wearable electronic devices, such as timepieces, and in particular, to an electronic device, such as for example and not limitation, a watch, that has multiple display functionality. More specifically, the electronic device of the present invention provides unique constructions and methodologies for displaying information with the use of hands, such as that found in analog watches (i.e. in an “analog manner”).

Originally, watches were typically viewed merely as a device for telling time or providing other time related information. Over the years, watches have become the means by which information, other than time information, could be presented to the wearer.

For example, U.S. Pat. No. 7,113,450 (“Plancon et al”) describes a watch with a multifunctional analog display. In one embodiment, a dial for an analog watch is provided with windows and one or more LCD panels are provided behind the dial and aligned with the respective windows. A controller is operable in a first mode and at least a second mode and the LCD display is viewable through the window in the dial, wherein the display displays informational indicia corresponding to the mode in which the electronic device is operating. U.S. Pat. No. 4,488,818 also describes the use of a dial formed by a liquid crystal display cell.

However, the present inventors believe further advances in the art are desirable. For example, a timepiece in which a cholesteric liquid crystal display (“ChLCD”) can be used provides advantages believed to be absent in the state of the art. For example, utilizing ChLCD technology provide for reduced power usage and an increase in aesthetic and multifunctional related opportunities.

It is thus believed that further advances are achievable. And, it is believed that the functionality and methodologies to provide the foregoing advantages and achieve the aforementioned objectives, as well as those set forth below, are provided by the present invention.

### SUMMARY AND OBJECTIVES OF THE INVENTION

It is thus an objective of the present invention to overcome the perceived deficiencies in the prior art.

For example, it is an objective of the present invention to provide a bi-stable display with improved reflective characteristics.

As but another example, it is an objective of the present invention to provide a display with good contrast and low power consumption.

It is yet another objective and advantage of the present invention to provide an electronic device that clearly displays, and makes easily comprehensible, information relating to data stored in the controller of the device, whether the information be time-based or nontime-based information, and whether or not the information is received from an external source, such as via a telephone link, computer link, sensors, wired or wirelessly, or the like.

It is another objective and advantage of the present invention to provide an electronic device that clearly displays, and makes easily comprehensible, information relating to external parameters, as well as time-based or nontime-based information that may be programmed into or otherwise stored in the electronic device.

It is a yet another object and advantage of the present invention to provide all of the foregoing in an electronic device, such as a wearable electronic device, such as a timepiece and a wristwatch in particular, that displays the information using hands that are coupled to actuation mechanisms, such as stepper motors.

Further objects and advantages of this invention will become more apparent from a consideration of the drawings and ensuing description.

The invention accordingly comprises the features of construction, combination of elements and arrangement of parts that will be exemplified in the disclosure hereinafter set forth, and the scope of the invention will be indicated in the claims.

To overcome the perceived deficiencies in the prior art and to achieve the objects and advantages set forth above and below, the present invention is, generally speaking, directed to wearable electronic devices, such as electronic timepieces.

In a preferred embodiment, the wearable multimode electronic device is of the type wherein information is conveyed in an analog manner at least in part by the use of at least one display hand, wherein the wearable electronic device includes a dial assembly having a dial side and an opposite side, wherein the display hand is positioned on the dial side of the dial assembly, and wherein the wearable multimode electronic device comprises an actuation mechanism, operatively coupled to the at least one display hand, for rotating the at least one display hand in at least one of a clockwise and counterclockwise direction in predefined increments; a controller, operable in a first mode and at least a second mode and operatively coupled to the actuation mechanism, for causing the actuation mechanism to rotate the at least one display hand in at least one of the clockwise and counterclockwise direction in the predefined increments; wherein the dial assembly is operatively coupled to the controller, and is a liquid crystal display assembly; wherein the dial assembly displays informational indicia corresponding to the mode in which the electronic device is operating, and wherein the informational indicia is changeable based on the mode in which the wearable electronic device is operating; and wherein the positioning of the display hand as it rotates in the one of the clockwise and counterclockwise directions in the predefined increments conveys the information by referring to particular informational indicia, and wherein the controller operatively controls the positioning of the hand so that the hand can convey the information in the analog manner for each of the at least two modes.

In a specific embodiment, the liquid crystal display is a cholesteric liquid crystal display.

### BRIEF DESCRIPTION OF THE DRAWINGS

The above set forth and other features of the invention are made more apparent in the ensuing Description of the Preferred Embodiments when read in conjunction with the attached Drawings, wherein:

FIG. 1 is a partial exploded view of an electronic device constructed in accordance with the present invention;

FIG. 2 is a simplified cross-sectional view of the electronic device of FIG. 1;

FIG. 3 is a perspective view of the movement side of the module in the electronic device of FIG. 1;

FIG. 4 is a circuit diagram for an electronic device constructed in accordance with the present invention;

FIG. 5 is a block diagram of a controller, constructed in accordance with the present invention for use in an electronic device constructed in accordance with the present invention;

FIG. 6 is a top plan view of the electronic device of FIG. 1 in an exemplary display format, in particular illustrating daytime hour demarcations and exemplary tide information;

FIG. 7 is a top plan view of the electronic device of FIG. 1 in another exemplary display format, in particular illustrating nighttime hour demarcations and an exemplary timer display;

FIG. 8 shows how the dial assembly of the present invention, comprising the dial itself, would preferably be able to show day and/or date changes;

FIG. 9 is a top plan view of the electronic device of FIG. 1 in another exemplary display format, in particular illustrating altitude information of a particular scale (x100);

FIG. 10 is a top plan view of the electronic device of FIG. 1 in a second exemplary altitude display format, in particular illustrating altitude information of a x1000 scale; and

FIG. 11 is a top plan view of the electronic device of FIG. 1 in yet another exemplary display format, in particular illustrating compass headings.

Identical reference numerals in the figures are intended to indicate like parts, although not every feature in every figure may be called out with a reference numeral.

### DESCRIPTION OF THE PREFERRED EMBODIMENTS

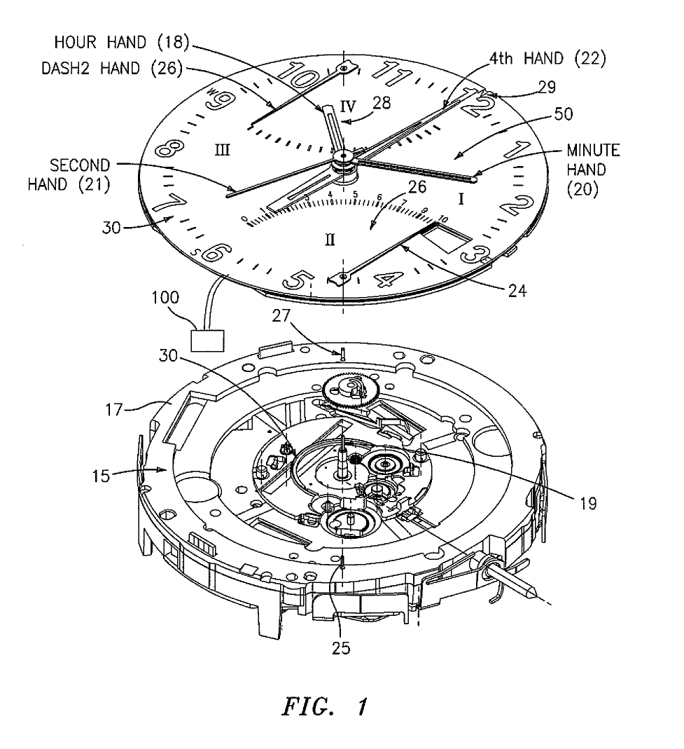

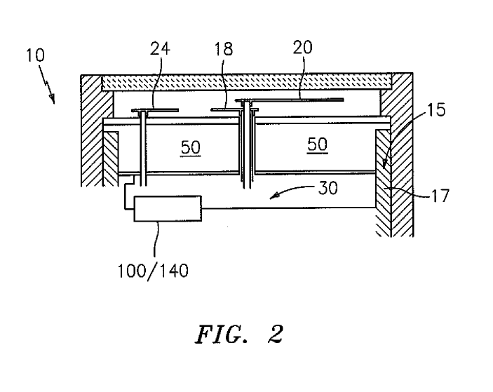

Reference is first made generally to FIGS. 1 and 2, which illustrate views of an electronic device, generally indicated at 10, constructed in accordance with the present invention. In the preferred construction, electronic device 10 is a timepiece, such as a wristwatch, which itself will thus comprise other features and parts, namely for example and not limitation, a wrist strap for securing electronic device 10 to a wrist. However, such features form no material part of the present invention.

Generally speaking, electronic device 10 comprises a module, generally indicated at 15, which itself includes a housing 17, in which are disposed many components, the material ones of which pertain to the present invention being hereinafter disclosed. However, it should be understood that the present disclosure will omit, for purposes of brevity, certain basic and very well known concepts regarding the construction of an analog or chronograph watch. For example, the basic construction and arrangements of gears and/or gear trains to rotate a plurality of “standard” hands all supported on a center stem 19, such as an hour hand 18, a minute hand 20 and a “seconds” hand 21, will be omitted as being well within the purview of one skilled in the art. However, for purposes of supporting the claims and providing an enabling disclosure, certain parts of such well-known mechanisms will be referenced throughout.

As can also be seen in FIG. 1, electronic device 10 may comprise one or more “display hands” aside from the conventional hour, minute and “seconds” hand. For example, FIG. 1 illustrates a hand 22 also mounted on center stem 19 and associated with a display 29 while other hands 24, 26 may be respectively mounted on stems 25, 27 and associated with separate displays 26, 28. It should be understood more or less display hands may be provided as desired or needed.

It is also believed that it is well understood by those skilled in the art how to provide one or more stems through a liquid crystal display. The subject matter of U.S. Pat. No. 4,488,818 and application Ser. No. 11/544,084 are incorporated herein by reference for just such exemplary teachings.

For reference, it can be seen that the hour hand and minute hand conveys time of day information and are rotatable about a center axis, and display hands 24 and 26 are rotatable about an axis other than the center axis.

A brief disclosure of a preferred hand movement system, generally indicated at 30, in connection with the present invention will now be disclosed. However, it should be understood that further details can be found in the aforementioned U.S. Pat. No. 7,113,450, the subject matter of which is incorporated by reference as if fully set forth herein.

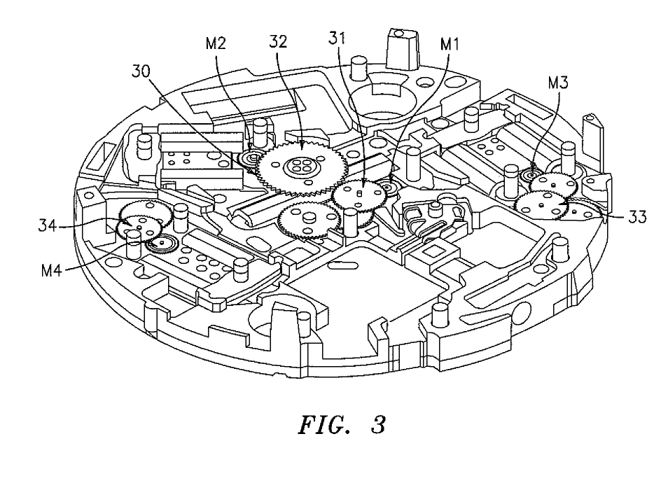

Reference will now also be made to FIG. 3, wherein the embodiment illustrated in FIG. 1 may comprise four stepper motors, each respectively and generally indicated by M1, M2, M3 and M4. One skilled in the art would recognize that varying the number of displays and display hands can vary the number of needed stepper motors, all of which is within the scope of the present invention and disclosure.

As positioned in module 15, motor M1 is provided to rotate hour hand 18, minute hand 20 and “seconds” hand 21 all in a known manner. Specifically, hour hand 18, minute hand 20 and “seconds” hand 21 are coupled to a gear train, generally indicated at 31, for conveying the rotational activity generated by the rotor of motor M1. In a similar manner, hand 22 is rotated by stepper motor M2, and a gear train generally indicated at 32 is provided to convey the rotational activity generated by the rotor of motor M2 to hand 22. Likewise, hands 24, 26 are each respectively rotated by stepper motors M3 and M4, and a gear train generally indicated at 33 is provided to convey the rotational activity generated by the rotor of motor M3 to hand 24, while a gear train generally indicated at 34 is provided to convey the rotational activity generated by the rotor of motor M4 to hand 26. The construction of the respective gear trains 31-34 are well within the purview of one ordinarily skilled in the art.

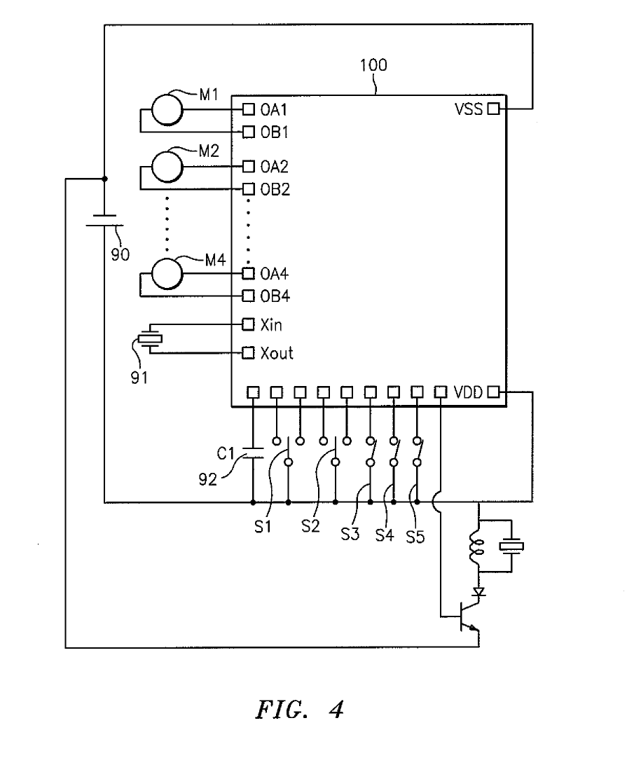

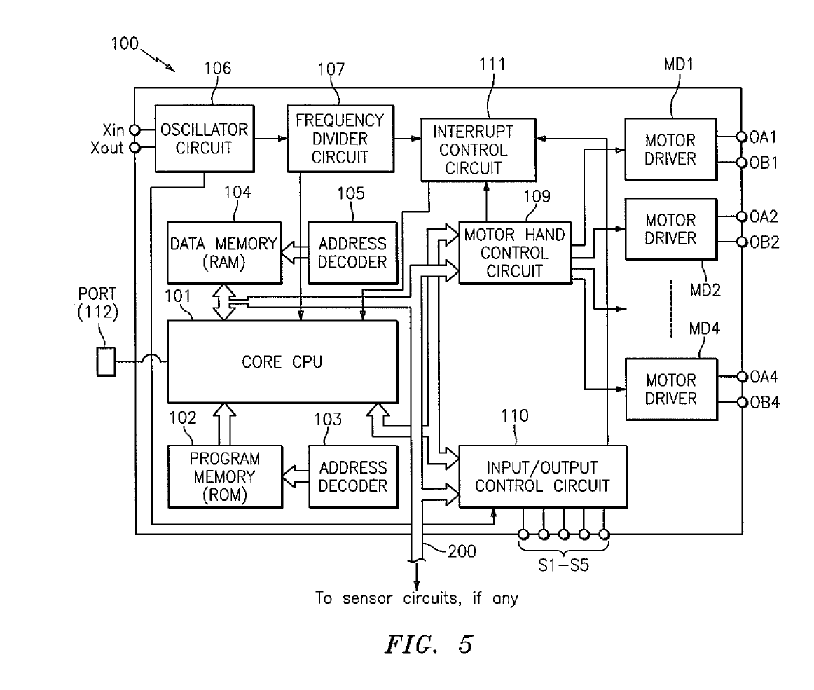

Reference is now made to FIG. 4, which illustrates a circuit diagram for a preferred construction of electronic device 10. Generally speaking, controller 100 is preferably an integrated microcontroller typically used with electronic watches which, as will be more particularly disclosed below with reference to FIG. 5, integrates onto a single chip, and preferably comprises a CPU core, a motor hand control circuit, an input/output control circuit, addressing and decoding functionality, memory and motor drivers.

As illustrated in FIG. 4, electronic device 10 preferably includes, among other things, a battery 90, a resonator 91 to provide basic timing, a filter capacitor 92 and interface connections to motors M1-M4 and switches S1-S5. A parallel sensor interface may be provided for receiving digital signals from a sensor embedded in electronic device 10 and/or a serial sensor interface may be provided for receiving data from a tethered sensor or wireless (remote) sensor.

By way of background, switches S1-S5 are intended to generically indicate both side/top mounted pushers, as well as side mounted rotatable crowns, and thus respond to the actuation (i.e. pulling and/or pushing) action thereof. In the case of crowns, the pulling and or pushing actuations may be provided for setting hands 18, 20 and 21, setting alarm(s) and or actuating backlighting capabilities. In the case of side mounted pushers, start/stop functions, mode selections and calibration of hands 22, 24 and 26 can be effectuated. Of course combinations of the foregoing are within the purview of one skilled in the art. Details of such side pushers or crown actuations/constructions are not material to the present invention, and therefore disclosure thereof is omitted.

Reference is now generally made to FIG. 5 for a description of a preferred construction of controller 100, as again, further details can be found in U.S. Pat. No. 7,113,450. As illustrated, controller 100 comprises a core CPU 101 which itself comprises an ALU, a calculation register, a stack pointer, an instruction register and an instruction decoder. Controller 100 utilizes a memory mapped I/O bus 200 to communicate with hand control circuit 109, input output control circuit 110 and sensor circuits that will be discussed in further detail below.

A ROM memory block 102 in cooperation with an address encoder 103 provide access to electronic device control software and fixed data. The methodology for the programming for directing CPU 101 on the steps and logic necessary to keep track of and determine subsequent motor positions, as discussed further below, is also coded into ROM 102. Reference may also be made to application Ser. No. 10/090,588, the subject matter of which is incorporated by reference as if set forth herein, for a disclosure of a preferred construction for driving and controlling a plurality of stepper motors.

A RAM memory block 104, in cooperation with an address decoder 105, provides storage for intermediate calculation values and also is used to hold current position of the various electronic device hands, such as hands 18, 20, 21, 22, 24 and 26, and to store changeable information such as pill schedules, tide tables, etc., that may be downloaded into controller 100 through a port, generically indicated by 112, which may be an IR port, a keyboard input, a port for optical transmission, LEDs, RF, or through a computer interface, such as that described in U.S. Pat. No. 5,488,571, coowned by the present assigned and incorporated by reference as if fully set forth herein.

Controller 100 includes oscillator circuit 106 which oscillates at a frequency determined by resonator 91, and in the preferred embodiment, this frequency of oscillation is 32768 Hz. A frequency divider circuit 107 divides the output of oscillator circuit 106 to generate appropriate timing signals for timekeeping, motor control and data acquisition functions.

A motor hand control circuit 109 receives a commanded “next number of pulses” from CPU core 101 and generates the pulsed and phased signals necessary to move a desired motor (M1-M4) a desired amount and in a desired direction. Pulse outputs of the motor hand control circuit 109 are buffered by motor drivers MD1-MD4 and applied to motors M1-M4.

An input/output control circuit 110 controls the crown actuations and pushbutton switches of FIG. 4 and provides such signaling information to CPU 101.

An interrupt control circuit 111 is connected to frequency divider circuit 107, motor hand control circuit 109 and input/output control circuit 110, and outputs timer interrupts, motor control interrupts, and key interrupts to CPU 101.

Again, reference to the aforementioned U.S. Pat. No. 7,113,450 may be had for disclosure of, among other things, a block diagram circuit elements to interface electronic device 10 to “the outside world,” such as that for controller 100 to directly or indirectly control the movement of the respective hands to display chronological data, analog representations of data stored in ROM and/or RAM, and analog representations of parameters measured through sensors. Such external parameters include, but are not limited to ambient temperature, altitude, body temperature, blood pressure, blood sugar levels, heart rate, and compass headings. Preferred embodiments of the invention may thus include one or more embedded, tethered or remotely coupled sensor circuits, all as disclosed in the aforementioned '450 Patent.

All of the foregoing makes clear that in an embodiment that may not utilize sensors to measure external parameters, controller 100 will have in its memory (or will be able to receive from an external source for storage in such memory) all the necessary data representative of the stored information such as tide or “pill-taking” information, by way of example, and in an electronic device that comprises one or more sensors, controller 100 will receive the necessary data representative of the measured parameter(s) via one or more sensor circuits.

As noted, analog hands 18, 20 and 21 are preferably used to indicate time and hands 22, 24 and 26 are preferably used to display either values stored in ROM 102, values stored in RAM 104 or current data collected by any sensors. Since the display of time information using stepper motors is known to one skilled in the art, the following discussion will address display of stored information and “live” information collected from such sensors.

Advantageously, and as is also known to those skilled in the art, a stepper motor will remain in its last position unless pulsed to move. Therefore to smoothly display continuously varying information with an analog hand driven by a stepper motor, the preferred embodiment delivers to the stepper motor the necessary number of pulses to move the rotor of the stepper motor between a desired position at t=0, for example, and a position desired after some small time interval later.

As indicated above, the preferred embodiment will utilize sensors with A/D conversion to facilitate computation and interface to the memory mapped I/O. Therefore to determine the number of pulses and direction to move a rotor of a stepper motor to its next position it is necessary to know where the rotor is in terms of a number of pulses, subtract that from the new sensor value converted to pulses, and based on the magnitude and sign of the difference, pulse the stepper motor the number of pulses needed to move the rotor the desired amount and in the desired direction.

In an alternate embodiment the calculations above can be performed using converted sensor values in digital format and then by applying the appropriate scale factors, develop the number of pulse determined above.

Selection and implementation of smaller or larger time intervals between sampling is well within the knowledge of one skilled in the art.

The '450 Patent provides a very suitable disclosure on the methodology for controller 100 to signal motor hand control circuit 109 to step the respective stepper motor a predetermined number of steps in a direction to indicate an increased value (if the new measurement is greater than the previous measurement) or in the opposite direction if the new measurement is less than the previous measurement.

Although the preferred construction is the use of stepper motors as disclosed herein, it should be understood that the present application is not so limited. For example, other types of actuation mechanisms, may be used in place of the stepper motors disclosed herein, while still remaining within the scope of the present invention. Accordingly, in these embodiments, it should be understood that an actuation mechanism would be operatively coupled to the controller and would rotate the at least one display hand in at least one of a clockwise and counterclockwise direction in predefined increments.

Once again, the '450 Patent (and the patents cited therein) describes a plurality of examples of using sensors to measure and display information, such as, but not limited to, altitude or compass headings, parameters such as body temperature, heart rate, blood sugar levels or blood pressure, or other physiological parameters using noninvasive techniques can be measured, including lung capacity.

The preferred dial assembly, generally indicated at 50, is a liquid crystal display assembly. In the preferred embodiment of the present invention, a conventional (e.g. Mylar) dial is thus omitted. Doing so provides the advantages set forth herein, some of which will be disclosed below.

Many publicly available documents provide adequate descriptions of how a liquid crystal display, and in the preferred embodiment, being a cholesteric liquid crystal display, works. Because it is believed that the construction of a cholesteric liquid crystal display is extremely well known by those skilled in the art (see, for example, all the existing patents assigned to Kent Displays, Inc. out of Kent, Ohio), the following is set forth presumably more to ensure completeness and as otherwise background information. Also, a more detailed description is provided in the aforementioned application Ser. No. 11/544,084.

It should thus be known to those skilled in the art that a preferred liquid crystal display being of the cholesteric type, which comprises a specific claimed dial assembly herein, preferably comprises a transparent glass, a plurality of liquid crystal units and a light-absorbing glass. Alternatively, as is known in the art, the liquid crystal display can be made flexible by utilizing flexible plastic materials in place of the glass components. When a voltage is applied to the dial assembly 30, the liquid crystal units of the reflective cholesteric liquid crystal display type will arrange according to the applied voltage. When there is no applied voltage, a cholesteric liquid crystal display element of the reflective type has two stable states: a planar texture and a focal conic texture.

The planar texture is a bright state, that is, the liquid crystal units arrange with a rule on the turn, and the outside light can be through the transparent glass, the liquid crystal units and the light-absorbing glass with half quantities reflect. On the other hand, the focal conic texture is a dark state, wherein the liquid crystal units irregularly arrange, and the outside light disorderly enters and is completely absorbed by the light-absorbing glass. When there is no applied voltage, the stable state of a reflective cholesteric liquid crystal display is determined by the previous applied voltage. That is, the preferred ChLCD preferably has a memory effect, as it is known that once writing of an image on the liquid crystal display is completed, the display is capable of displaying the image continuously even after the supply of electric power thereto is stopped, which means the liquid crystal display consumes little electric power.

It is assumed that those skilled in the art, as set forth in the aforementioned '084 application, know that the pixels in a display section of a cholesteric liquid crystal display are controlled by a plurality of column electrodes C1, C2 and a plurality of row electrodes R1, R2. The pixels are disposed on crossing areas between the column electrodes and the row electrodes. However, for completeness, the following is set forth:

In a simplified example, controller 100 may be coupled to a driver, which itself is coupled to the ChLCD assembly. One or more busses of row and column lines/electrodes are provided to operate the corresponding number of displays, as disclosed herein. Thus, the number of actual lines is dictated by the number of displayable areas desired on dial assembly 50, and thus the proper number and method of operationally coupling the LCD, whether a ChLCD or otherwise, to the driver and/or controller circuitry would be understood by one skilled in the art. In this way, the driving means can provide driving signals to the respective display sections and the controller, operatively coupled to the driving means, can provide signaling to the driving means to provide the driving signals. It should also be understood that the underlying circuitry and timekeeping functionality to provide the proper signaling and keep the proper time, date, and day information (and hour demarcations) is well known to those skilled in the art. Reference numeral 140 is provided in FIG. 2 to generally reference all of the foregoing and/or needed hardware and software therefor. Also, the spacing shown between layers and/or the relative size of the layers in the figures are merely for convenience and do not represent any specific dimensions, as it would surely be understood by those skilled in the art.

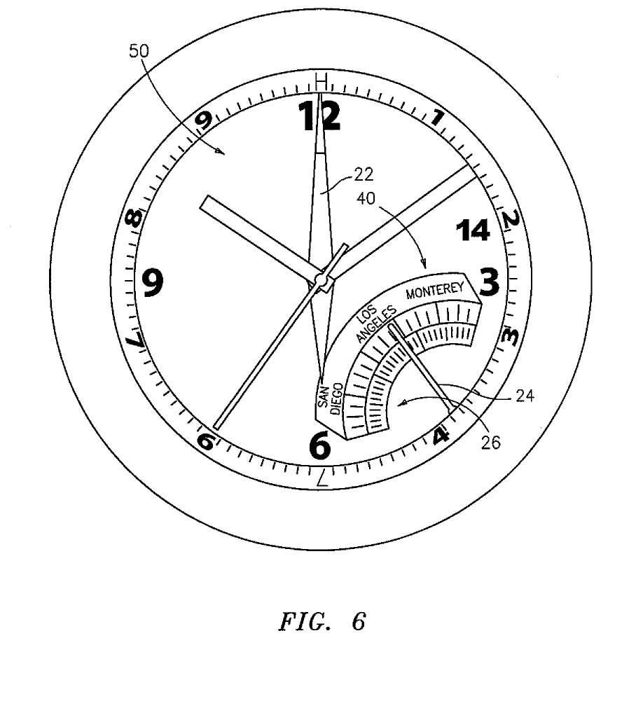

Features and advantages of the present invention will now be made with reference to FIGS. 6-11, which illustrate exemplary embodiments/displays provided by the present invention.

For example, FIG. 6 illustrates an example that need not rely on the use of sensors to provide information regarding external parameters, and displays information, in an easily readable manner, that has been previously stored in controller 100, and it should be reemphasized that the present disclosure provides the platform by which any number of informational parameters can be displayed by electronic device 10. Specifically, FIG. 6 illustrates an electronic device for displaying tide information along the California coast, such as whether the tide is high or low, and the geographic location pertaining thereto. In particular, hand 22 may be used to display the height of the tide, while one of the display areas (here by example, display area 26) is used to display various locations pertaining thereto. Hand 24 will point to the particular location. Moon phases or other related information could also be simultaneously displayed. One or more pushers S1-S5 may be used to cycle through various locations so that with each successive actuation of the pusher, hand 24 moves one position to point to a different location, with hand 22 thus working together to indicate the tide at that different location. One skilled in the art would clearly know how to program controller 100 to receive the pusher actuations and change the positioning of hand 24, at least based in part on the foregoing disclosure regarding hand movement. With all the data of the tide locations in memory, pusher actuations could actually be used to change the displays so that a user could view any desired location merely by scrolling through a set of geographic locations. U.S. Pat. No. 5,299,126 describes an embodiment wherein memory stores the applicable table of tide times, heights and geographic offsets, which would be helpful in constructing a tide watch that utilizes the features and construction of the present invention.

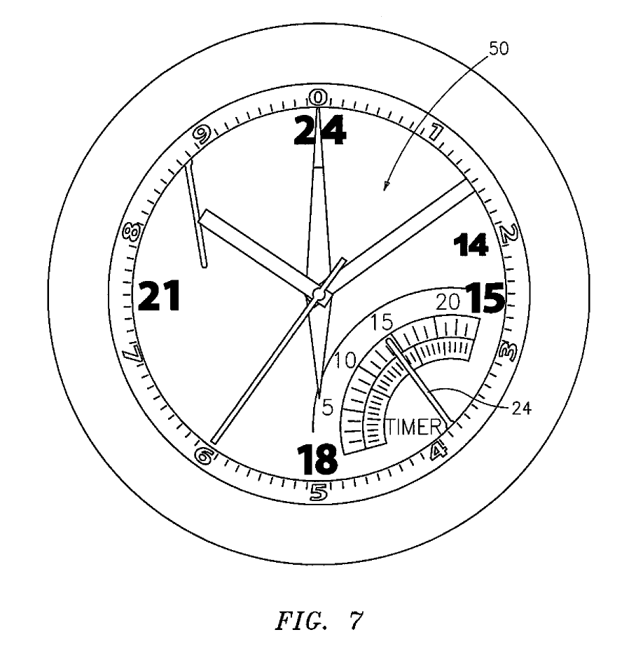

Just as importantly, FIG. 6 illustrates that the hour demarcations indicate “12,” “3,” “6” and “9.” Thus, during the first 12 hours of a 24 hour day, one set of hour demarcations may be visible. However, in the afternoon through the evening hours, dial assembly 50 may change to display different hour demarcations, such as “24,” “15” “18” and “21.” This is illustrated in FIG. 7. The disclosure of U.S. Pat. No. 7,027,361, which is incorporated by reference as if fully set forth herein, provides a suitable methodology and construction to provide for the signaling when the hour hand passes through a midnight hour. Obviously, one skilled in the art could adapt this technique to indicate when the hour hand passes through a noon time as well.

FIG. 7 also illustrates for example, how display 50 can be used as a count-down timer, with hand 24 being used to display the number of minutes left. In connection with this FIG. 7, controller 100 would be appropriately programmed to permit a user to set the desired number of minutes for the countdown timer. Again, such information could be inputted through the use of a side pusher. The number of actuations of the side pusher would cause controller 100 to cause motor hand control circuit 109 to step the appropriate rotor the proper number of steps to indicate an additional minute was selected for the countdown timer and/or would cause display 26 to change the scale (e.g. a 10 minute countdown timer vs. 20 minute countdown timer). Since controller 100 is operatively coupled to dial assembly 50 and controls what will be displayed on dial assembly 50 (since there is preferably no covering Mylar dial, for example), the dial assembly itself is easily changeable with the changes easily viewable to a user.

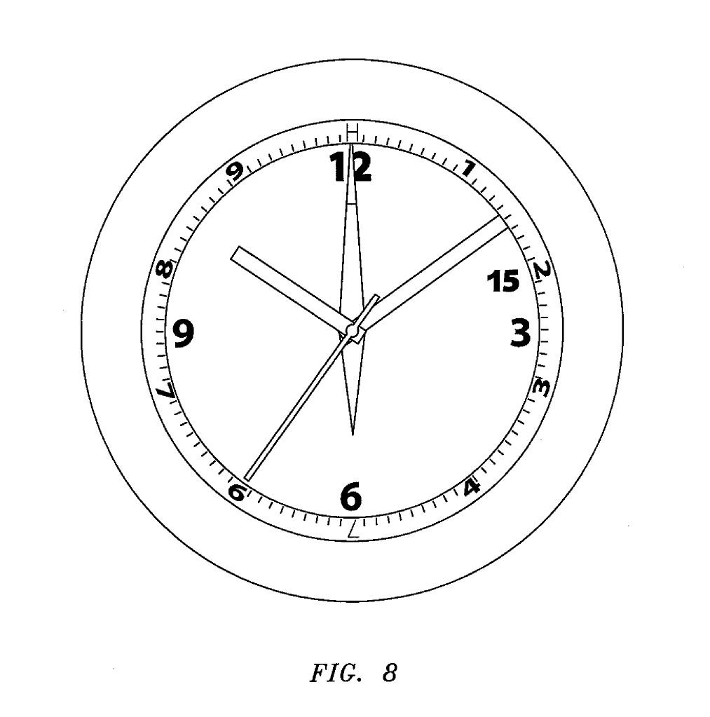

FIG. 8 is provided to show a generic electronic device 10 where the date has changed from the 14^{th} of the month to the 15^{th}. Hereto, the use of a liquid crystal display, and a cholesteric liquid crystal display in particular, allows for a day or date display (or month display if desired) using only low power consumption because of the advantages of the cholesteric LCD, as set forth above.

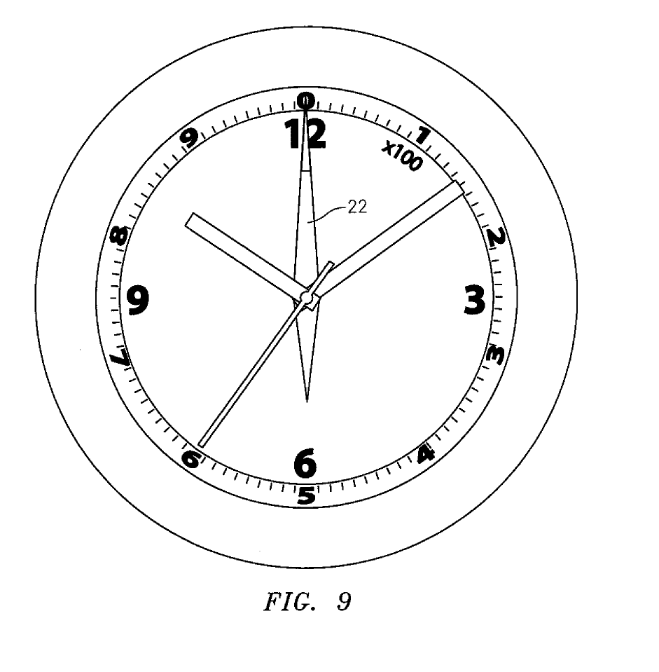

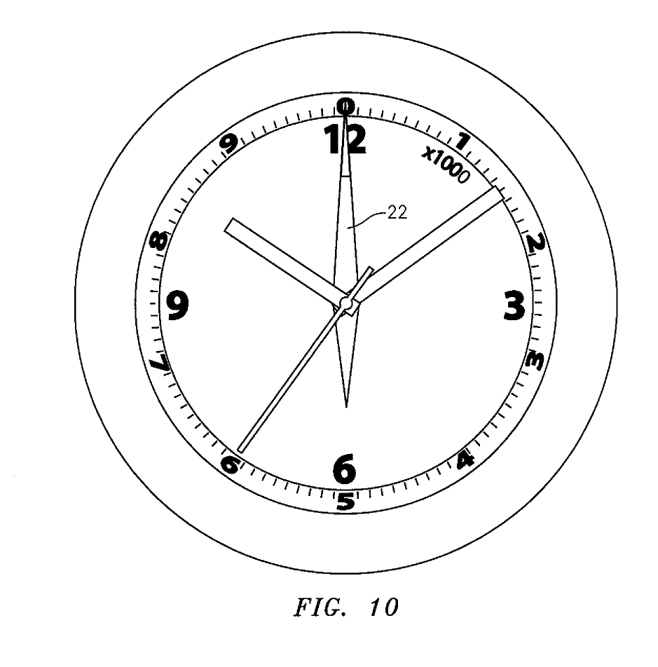

FIGS. 9 and 10 illustrate yet another example of the present invention whereby dial assembly 50 displays altitude information. In particular, in FIG. 9 hand 22 displays altitude while dial assembly 50 displays an x100 scale. FIG. 10 illustrates how the dial assembly 50 could be changed upon, for example, a detection of a threshold altitude such that the display changes to indicate that it is using an x1000 scale. Obviously, in this embodiment, one or more sensors would preferably be needed. The prior art, such as U.S. Pat. No. 5,224,059, describes a device for measuring altitude and barometric pressure, and therefore, the subject matter regarding the measuring of altitudes and barometric pressure therefrom is incorporated by reference as if fully set forth herein.

Thus with the incorporation of LCD display as the dial itself, the scales of the displays could vary based on the sensed parameter readings, i.e. the higher one goes, the scales change to provide the user with a more accurate hand indication. In a divers watch for example, the scale of depth of the dial assembly could vary from 1-10 feet, to 1-100 feet, to 1-1000 feet, as the sensor recognizes that the diver is increasing his/her depth.

Likewise, one or more sensors could be used to display heartrate, body temperature, blood pressure, blood sugar levels, and in accordance with the present invention, the dial assembly display itself will change depending on the display and function desired. Again, the controller and driver circuitry would be programmed to excite those pixels for which it is desired to change the display.

To be sure, the smaller displays (i.e. displays 26, 28) could also be used and can be varied to display such parameters as heartrate information, blood pressure, etc.

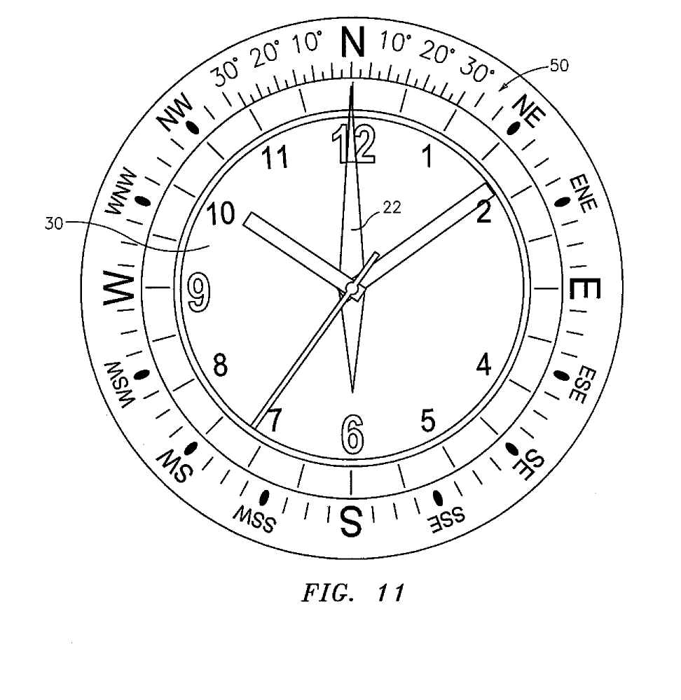

Lastly, for one additional but not exhaustive example, FIG. 11 illustrates dial assembly 30 in connection with displaying direction headings (i.e. a compass watch), with directional indicia thereon. In this specific embodiment, electronic device 10 will preferably include a sensor circuit, with directional information being received by controller 100, and through motor hand control circuit 109, hand 22 will rotate accordingly based on the pulsing scheme provided by controller 100 to circuit 109, as in the manner disclosed above.

The use of the foregoing constructions and arrangements to display tide/moon information, pill taking and timers should be considered exemplary and not in a limiting sense, as one skilled in the art should be able to envision many other advantageous uses of the present invention, all while remaining within the scope of the claims.

It can thus be seen that dial assembly 50 can display various scales (or displays for different parameters) that are particular to the desired displayable information. In this way, a single electronic device can be manufactured with all of the aforementioned modes being selectively displayable on one (or more) display and in one electronic device. Additionally and/or alternatively, dial assembly 50 could display the actual mode titles (e.g. “HR,” “TIMER,” “BP,” “COMPASS,” etc.), thus allowing the user an ability to see the modes through which he/she is cycling. In a similar manner, the scales for a single mode can vary as well, since one skilled in the art would know how to excite the appropriate LCD crystals to have a scale, grid or other measuring design appear on the top surface of dial assembly 50.

Moreover and importantly, controller 100, knowing the mode, the scale appearing on the top surface of dial assembly 30, and the position of the rotors for the appropriate motors M1-M4, could coordinate the display such that any mode could be displayed by the use of differing displayable scales.

It will thus be seen that the present invention is both patentably different from and a significant improvement over the cited prior art timepieces. Specifically, the present invention provides a unique way to clearly display, and makes easily comprehensible, information relating to external parameters, as well as time-based or nontime-based information (e.g. hour demarcations) that may be programmed into or otherwise stored in the timepiece. Additionally, the present invention can incorporate a wide range of sensor circuits and arrangements for measuring external parameters and have such measurements clearly displayable and easily comprehensible, and provides an improved method, approach and thus construction to display whatever inputs it receives from the sensors.

Most importantly, the present invention provides that the display of such information is on a dial assembly, which itself is a liquid crystal display and makes up the dial itself, and in the preferred embodiment, is a cholesteric liquid crystal display.

One other important feature is worthy of mention, namely an autocalibration feature, which is also disclosed in U.S. Pat. No. 7,113,450 as well as U.S. Patent Application Publication No. 20040233791, entitled “Method And Construction For Autocalibrating An Actuation Mechanism In An Electronic Device,” and the subject matter of which is also incorporated by reference as if fully set forth herein. In this way and because of the present invention's versatility in displaying multiple parameters on one display, the present invention incorporates unique autocalibration algorithms and constructions to ensure that the display hands are always positioned correctly. In this way, even when a different display is desired (e.g. going from an altitude display (e.g. FIG. 9) to a compass display (e.g. FIG. 11)) or even if the scales of a display are merely changing (e.g. from that disclosed in FIG. 9 to FIG. 10), the hands can always be calibrated to, for example, a desired “0” position. In this way, the controller will always be able to adjust display hand movement (and positioning) with the display being shown on dial assembly 30.

While the invention has been particularly shown and described with respect to preferred embodiments thereof, it will be understood by those skilled in the art that changes in form and details may be made therein without departing from the scope and spirit of the invention.

For example, the multipurpose platform disclosed herein is applicable to the display of a wide range of additional parameters using a wide range of additional sensors, such as but not limited to, water pressure, water depth and oxygen left in a diver's tank (i.e. a diver's watch); air pressure and moisture (i.e. a weather watch); object finder (i.e. to find one's car or way back to a starting location); blood/sugar levels (a glucometer); speed and distance (a runner's watch); displaying how much money is in a debit account; and any combination of the foregoing, since the novelty lies in the multidisplay capabilities of the present invention and the dial assembly itself being of an LCD type in general and a cholesteric display in particular. As set forth above, multiple sensors can provide for a plurality of displays.

What is claimed is:

1. A wearable multimode electronic device of the type wherein information is conveyed in an analog manner at least in part by the use of at least one display hand, wherein the wearable electronic device includes a dial assembly having a dial side and an opposite side, wherein the display hand is positioned on the dial side of the dial assembly, wherein the wearable multimode electronic device comprises:
an actuation mechanism, operatively coupled to the at least one display hand, for rotating the at least one display hand in at least one of a clockwise and counterclockwise direction in predefined increments;
a controller, operable in a first mode and at least a second mode and operatively coupled to the actuation mechanism, for causing the actuation mechanism to rotate the at least one display hand in at least one of the clockwise and counterclockwise direction in the predefined increments;
wherein the dial assembly:
is operatively coupled to the controller, and
is a liquid crystal display assembly;
wherein the dial assembly displays informational indicia corresponding to the mode in which the electronic device is operating, and wherein the informational indicia is changeable based on the mode in which the wearable electronic device is operating; and
wherein the positioning of the display hand as it rotates in the one of the clockwise and counterclockwise directions in the predefined increments conveys the information by referring to particular informational indicia, and wherein the controller operatively controls the positioning of the hand so that the hand can convey the information in the analog manner for each of the at least two modes.

2. The wearable multimode electronic device as claimed in claim 1, wherein the electronic device comprises:
at least an hour hand and a minute hand for conveying time of day information and rotatable about an axis; and
wherein the controller causes the actuation mechanism to rotate the at least one display hand in at least one of the clockwise and counterclockwise direction in the predefined increments based at least in part on data stored in the controller;
wherein the positioning of the display hand as it rotates in the one of the clockwise and counterclockwise directions in the predefined increments conveys information relating to the stored data.

3. The wearable multimode electronic device as claimed in claim 1, wherein the electronic device comprises:
at least an hour hand and a minute hand for conveying time of day information and rotatable about an axis; and
wherein the controller (i) causes the dial assembly, in the first mode, to display first indicia regarding time information and in the second mode, to display second indicia regarding time information and (ii) causes the actuation mechanism to rotate the hour and minute hand in at least one of the clockwise and counterclockwise directions in predefined increments;
wherein the positioning of the hour and minute hand as they rotate in the one of the clockwise and counterclockwise directions in the predefined increments conveys time information.

4. The wearable multimode electronic device as claimed in claim 3, wherein the first indicia comprises hour demarcations indicating daytime hours and the second indicia comprises hour demarcations indicating evening hours.

5. The wearable multimode electronic device as claimed in claim 1, wherein the liquid crystal display is an LCD display.

6. The wearable multimode electronic device as claimed in claim 1, wherein the liquid crystal display is an ChLCD display.

7. The wearable multimode electronic device as claimed in claim 1, wherein the actuation mechanism comprises a stepper motor that itself comprises a rotor, the stepper motor operatively coupled to the controller, for stepping in at least one of a clockwise and counterclockwise direction in predefined increments based at least in part on the data stored in the controller;
wherein the rotor of the stepper motor is operatively coupled to the at least one display hand, and wherein the rotation of rotor causes the rotation of the at least one display hand in at least one of the clockwise and counterclockwise directions and in the predefined increments.

8. The wearable multimode electronic device as claimed in claim 1, wherein no plastic dial is provided between the liquid crystal display and the at least one display hand.

9. A wearable multimode electronic device of the type wherein information is conveyed in an analog manner at least in part by the use of at least one display hand, wherein the wearable electronic device includes a dial assembly having a dial side and an opposite side, wherein the display hand is positioned on the dial side of the dial assembly, wherein the wearable multimode electronic device comprises:
an actuation mechanism, operatively coupled to the at least one display hand, for rotating the at least one display hand in at least one of a clockwise and counterclockwise direction in predefined increments;
a controller, operable in a first mode and at least a second mode and operatively coupled to the actuation mechanism, for causing the actuation mechanism to rotate the at least one display hand in at least one of the clockwise and counterclockwise direction in the predefined increments;
wherein the dial assembly:
is operatively coupled to the controller, and
consists of a liquid crystal display assembly, wherein no plastic dial is provided between the liquid crystal display and the at least one display hand;
wherein the dial assembly displays informational indicia corresponding to the mode in which the electronic device is operating, and wherein the informational indicia is changeable based on the mode in which the wearable electronic device is operating; and
wherein the positioning of the display hand as it rotates in the one of the clockwise and counterclockwise directions in the predefined increments conveys the information by referring to particular informational indicia, and wherein the controller operatively controls the positioning of the hand so that the hand can convey the information in the analog manner for each of the at least two modes.

10. A wearable multimode electronic device of the type wherein information is conveyed in an analog manner at least in part by the use of at least an hour hand, comprising:
a dial assembly having a dial side and an opposite side, wherein the display hand is positioned on the dial side of the dial assembly;
controller means for maintaining date information and for displaying date information on the dial assembly;
wherein the dial assembly is operatively coupled to the controller and is a cholesteric liquid crystal display.

11. The wearable multimode electronic device as claimed in claim 10, comprising midnight means for indicating when a 24 period has elapsed, wherein the midnight means is operatively coupled to the controller means, for causing the date information on the dial assembly to change.

12. The wearable multimode electronic device as claimed in claim 10, comprising manual adjustment means, operatively coupled to the controller means, for causing the date information on the dial assembly to change.
